(19) United States
(12) Patent Application Publication
(10) Pub. No.: US 2026/0002888 A1
(43) Pub. Date: Jan. 1, 2026

(54) PORTABLE X-RAY AND CT SCAN SYSTEM

(71) Applicants: Southwest Research Institute, San Antonio, TX (US); FEDERAL BUREAU OF INVESTIGATION, Washington, DC (US)

(72) Inventors: Charles H. SHIN, JR., Oakton, VA (US); Nicholas Adam HERRERA, San Antonio, TX (US); Alan David CRAIG, Boerne, TX (US); Brian Michael JOHNSON, Shertz, TX (US)

(21) Appl. No.: 18/755,842

(22) Filed: Jun. 27, 2024

(51) Int. Cl. G01N 23/046

(52) U.S. Cl. CPC G01N 23/046; G01N 2223/301; G01N 2223/304; G01N 2223/308; G01N 2223/3303; G01N 2223/419

(57) ABSTRACT

Field-deployable, portable X-Ray system that includes an X-Ray detector package housed within a first portable container; the X-Ray detector package comprising a controllable X-Ray detector panel configured to generate an X-Ray image and controllable detector motor circuitry configured to control a position of the X-Ray detector panel. The system also includes an X-Ray source package housed within a second portable container; the X-Ray source package comprising a controllable X-Ray source configured to generate X-Ray energy toward the controllable X-Ray detector panel and toward an item placed between the X-Ray source and the X-Ray detector panel, and controllable source motor circuitry configured to control a position of the X-Ray source.

### STATEMENT REGARDING FEDERALLY SPONSORED RESEARCH OR DEVELOPMENT

This invention was made with government support under Federal Bureau of Investigation, OTD-TOS-SOSU, contract number DJF141200V0002644. The government has certain rights in the invention.

### FIELD

The present disclosure is generally directed to portable X-Ray and CT scan systems.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates a portable X-Ray and computed tomography (CT) scan system according to embodiments of the present disclosure;

FIGS. 2A-2E illustrate a portable X-Ray and CT scan system according to one embodiment of the present disclosure;

FIGS. 3A-3D illustrate a portable X-Ray and CT scan system according to another embodiment of the present disclosure; and

FIG. 4 illustrates an example GUI according to one embodiment of the present disclosure.

Although the following Detailed Description will proceed with reference being made to illustrative embodiments, many alternatives, modifications and variations thereof will be apparent to those skilled in the art.

### DETAILED DESCRIPTION

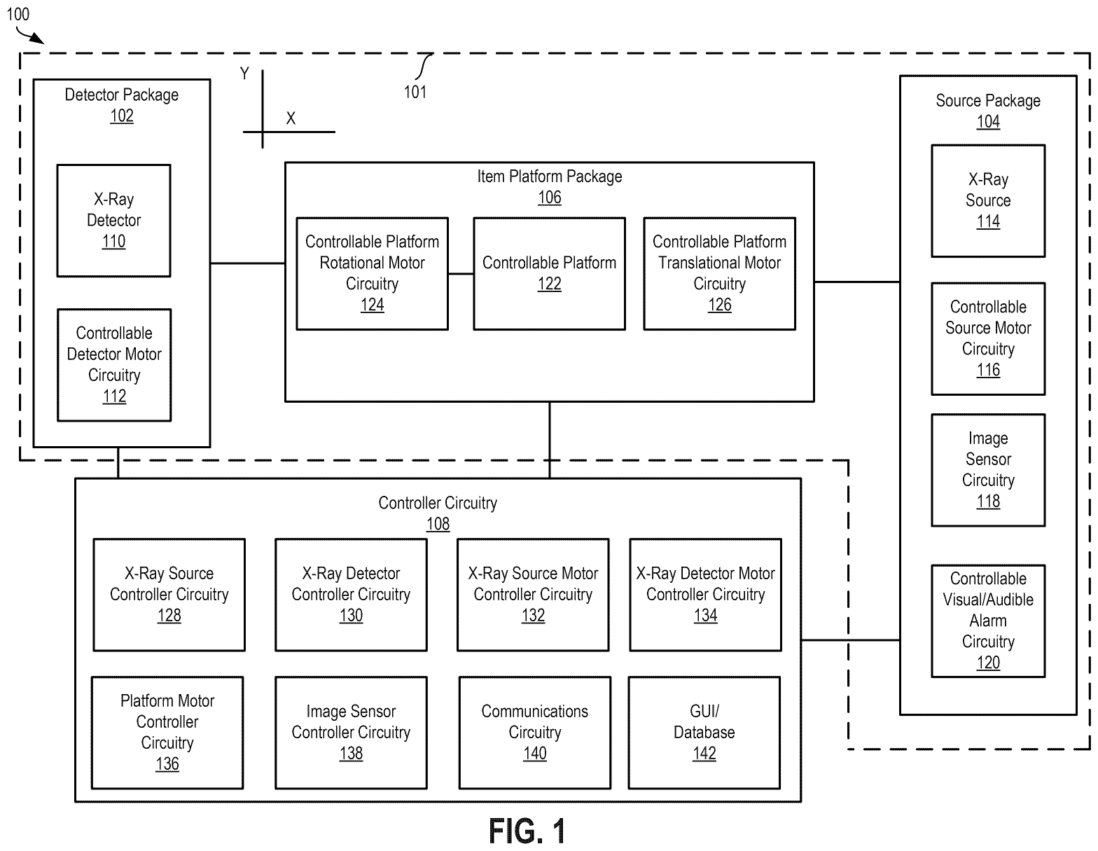

FIG. 1 illustrates a portable X-Ray and computed tomography (CT) scan system 100 according to embodiments of the present disclosure. The system 100 generally includes an X-Ray detection package 102, an X-Ray source package 104, and in some embodiments, an item platform package 106. The system 100 is generally configured to provide field-deployable, and portable X-Ray inspection of, for example, shipping parcels (e.g., various packages as may be found at airports, shipping ports, truck containers, etc.) and/or industrial items (e.g., pipe, electronic components, etc.), etc. As will be described in greater detail below, the X-Ray detection package 102, the X-Ray source package 104, and in some embodiments, the item platform package 106 may be contained within one or more mobile containers, as generally illustrated by dashed outline 101. The system 100 may also include controller circuitry 108 generally configured to control various aspects of the X-Ray detection package 102, the X-Ray source package 104, and the item platform package 106, as described in greater detail below.

The X-Ray detection package 102 includes a movable X-Ray detector 110. The X-Ray detector 110 is generally configured to receive X-Ray energy from a source (described below) to generate an X-Ray image (or series of X-Ray images for a 3D CT scan) of an item positioned on the item platform package 106. The X-Ray detector 110 may be selected for a desired weight/size, operational parameters, resolution, etc., and may further be selected based on desired operational speed (for example, selected to be able to receive X-Ray energy for both X-Ray images and CT images, etc.), etc. By way of example, the X-Ray detector 110 may include a Varex Imaging Panel (part number 4343CT-F22-K-070) with a resolution of approximately 150 microns and configured to generate 16-bit, 2880×2880 images, and/or other known and/or proprietary X-Ray detectors. To control movement of the X-Ray detector 110, the X-Ray detection package 102 also includes controllable detection motor circuitry 112 generally configured to controllably move the X-Ray detector 110 to a desired position for X-Ray imaging. The controllable detection motor circuitry 112 may be embodied as, for example, a servo motor system, linear motor system, etc., and may further be configured to orient the face of the X-Ray detector 110 to a controllable position. In some embodiments, the controllable detection motor circuitry 112 may include mechanical linkage, etc. (not shown in this drawing) generally configured to move the X-Ray detector 110 to a desired Y position (up/down), and/or a desired rotational position about the Y axis (the X and Y axes are noted in FIG. 1).

The X-Ray source package 104 includes a movable X-Ray source 114. The X-Ray source 114 is generally configured to controllably generate X-Ray energy, and to direct X-Ray energy toward the detector 110 with sufficient energy to pass through an item placed on the item platform package 106. The X-Ray source 114 and may be dimensioned for a desired weight/size, operational parameters, resolution, etc., and may further be selected based on desired operational energy, desired operational energy (for example, selected to be able to generate both energy for both X-Ray images and CT images, etc.), operational speed etc. In some embodiments, the X-Ray source 114 may be embodied as a high voltage X-Ray source (rather than a radioactive element X-Ray source), and may also be selected to have a resolution of between 5 and 50 microns. By way of a specific example, the X-Ray source 114 may include a MicroFocus X-Ray source manufactured by Hamamatsu (e.g., model No. L12161-07), and/or other known and/or proprietary X-Ray sources. To control movement of the X-Ray source 114, the X-Ray source package 104 also includes controllable source motor circuitry 116 generally configured to controllably move the X-Ray source 114 to a desired position for X-Ray imaging. The controllable source motor circuitry 116 may be embodied as, for example, a servo motor system, linear motor system, etc., and may further be configured to orient X-Ray source 114 toward the face of the X-Ray detector 110 to a controllable position, to generate an X-Ray image (or series of X-Ray images for a 3D CT scan) of an item positioned on the item platform package 106. In some embodiments, the controllable source motor circuitry 116 may include mechanical linkage, etc. (not shown in this drawing) generally configured to move the X-Ray source 114 to a desired Y position (up/down), and/or a desired rotational position about the Y axis (the X and Y axes are noted in FIG. 1).

The X-Ray source package 104 may also include image sensor circuitry 118 generally configured to capture an image to generate an X-Ray image of an item positioned on the item platform package 106. The image sensor circuitry 118 may enable, for example, image data to be cross-referenced with an X-Ray image or CT scan of an item positioned on the item platform package 106. The X-Ray source package 104 may also include controllable visual and/or audible alarm circuitry 120 generally configured to provide a visual and/or audible alarm when the X-Ray source 114 is operational, for example, to warn users of X-Ray energy in use.

The system 100 may also include an item platform package 106 generally disposed between the source package 104 and the detector package 102. The item platform package 106 includes a controllable platform 122 generally configured to rotate and/or translate an item placed thereon, to enable various X-Ray views of the item and/or contents of the item. For example, if the item is a sealed container, rotating and/or translating the item during X-Ray image capture may provide enhanced determination of the nature and identity of contents within the sealed container. Accordingly, the item platform package 106 may also include controllable platform rotational motor circuitry 124 generally configured to controllably rotate (e.g., rotate about the Y axis) the controllable platform 122 so that X-Ray images of an item placed on the controllable platform 122 can be taken at various views. In some embodiments, the item platform package 106 may also include controllable platform translational motor circuitry 126 generally configured to controllably translate (e.g., move along the X axis between the X-Ray detector 110 and X-Ray source 114) the controllable platform 122 so that X-Ray images of an item placed on the controllable platform 122 can be taken at various magnifications and resolutions. For example, moving an item placed on the controllable platform 122 closer to the X-Ray detector 110 may provide X-Ray images that have reduced magnification, but greater resolution; while moving an item placed on the controllable platform 122 closer to the X-Ray source 114 may provide X-Ray images that have increased magnification, but lower resolution.

The controller circuitry 108 is generally configured to exchange commands and data with the detector package 102, source package 104, and/or the item platform package 106, and to receive X-ray images generated by the source package 104 and detector package 102. The controller circuitry 108 may be embodied as, for example, a portable computing device which may include a laptop computer and/or other known portable computing devices such as, an iPad, iPhone, etc., and may include display devices and one or more human input devices (e.g., keyboard, mouse, touch screen, etc.) to enable a user to interact with the controller circuitry, as is well known. In some embodiments the controller circuitry 108 may be integrated with, for example, the detector package 102, the source package 104, and/or the item platform package 106.

The controller circuitry 108 includes X-ray source controller circuitry 128 generally configured to control the operation (e.g., turning on and turning off) Of the X-ray source 114. The controller circuitry 108 also includes X-ray detector controller circuitry 130 generally configured to control the operation of the X-ray detector 110 and to receive X-ray images from the X-ray detector 110. The controller circuitry 108 also includes X-ray source motor controller circuitry 132 configured to control the controllable source motor circuitry 116 to cause the X-ray source 114 to move into a targeted position. The controller circuitry 108 also includes X-ray detector motor controller circuitry 134 configured to control the controllable detector motor circuitry 112 to cause the X-ray detector 110 to move into a targeted position, for example, in alignment with the X-ray source 114.

The controller circuitry may also include platform motor controller circuitry 136 configure to control the rotational motor circuitry 124 and/or the translational motor circuitry 126, as described above. Controlling the rotational motor circuitry 124 provides the ability to obtain X-Ray images of an item at various views. The controller circuitry 108 may also include image sensor controller circuitry 138 generally configured to control the operation of the image sensor circuitry 118, and to receive image data from the image sensor circuitry 118.

The controller circuitry 108 of this embodiment also includes communication circuitry 140 generally configured to exchange commands and data with the X-Ray detection package 102, the X-Ray source package 104, and in some embodiments, the item platform package 106 and/or with a remote system (not shown, for example remote cloud storage, etc.). The communications circuitry 140 may communicate using a known and/or after-developed communications protocols including, for example, cellular communications protocols (e.g., LTE, 3G, 4G, 5G/6G, etc.), wired and/or wireless network communications protocols (e.g., IEEE 10 BASE x, WiFi, etc.), etc., near-field communications protocols (e.g., Bluetooth, etc.), etc. and/or other known or after-developed communications protocols. In some embodiments, for example, if the system 100 is deployed in a remote location outside of cellular/wifi coverage, communications circuitry 140 may be configured to communicate using satellite communications protocols, etc. Communications circuitry 140 may also include antennae systems (e.g., direction and/or polar antennae arrays, etc.) and/or signal boosting circuitry (not shown) to enable greater range of communications.

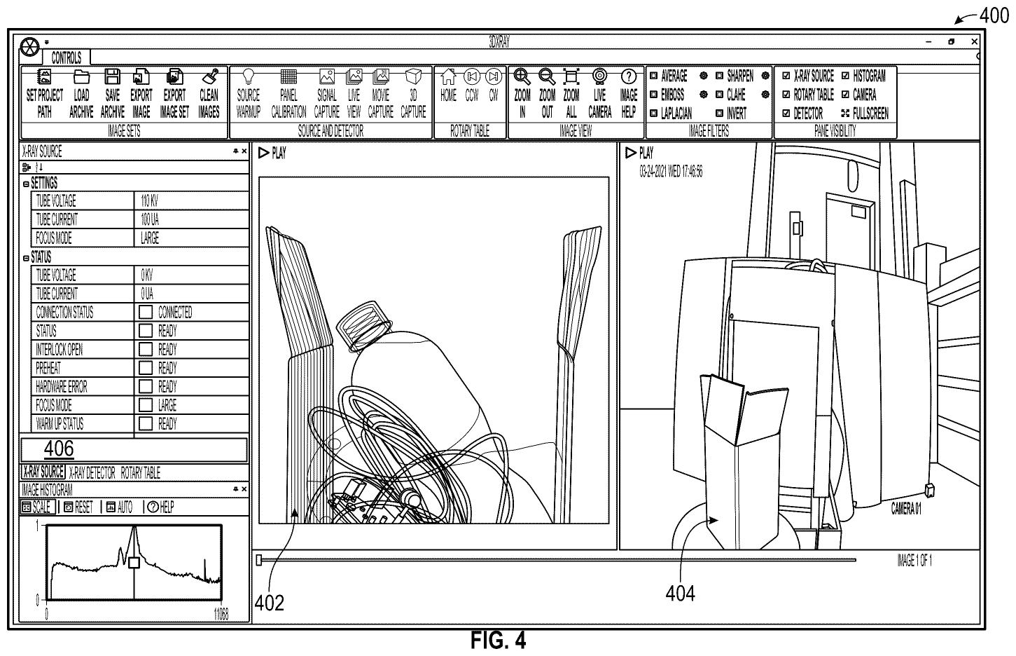

The controller circuitry 108 may also include graphical user interface (GUI) and database circuitry 142 generally configured to provide a user with an interaction interface to control various aspects of the system 100, as described above, and to provide database storage and retrieval of X-Ray images, CT scan images and/or visual images of an item that has been inspected. The database may be configured to link (cross-reference) an item using X-Ray images and corresponding visual images and may also include an identification tag, time/date stamp information, etc. The GUI may also be configured to highlight an area of interest in an X-Ray image for further inspection, which may include, for example further user-controlled manipulation of rotation, resolution and/or magnification of an X-Ray image using the controllable platform 122, as described above. An example of a GUI is described below in reference to FIG. 4.

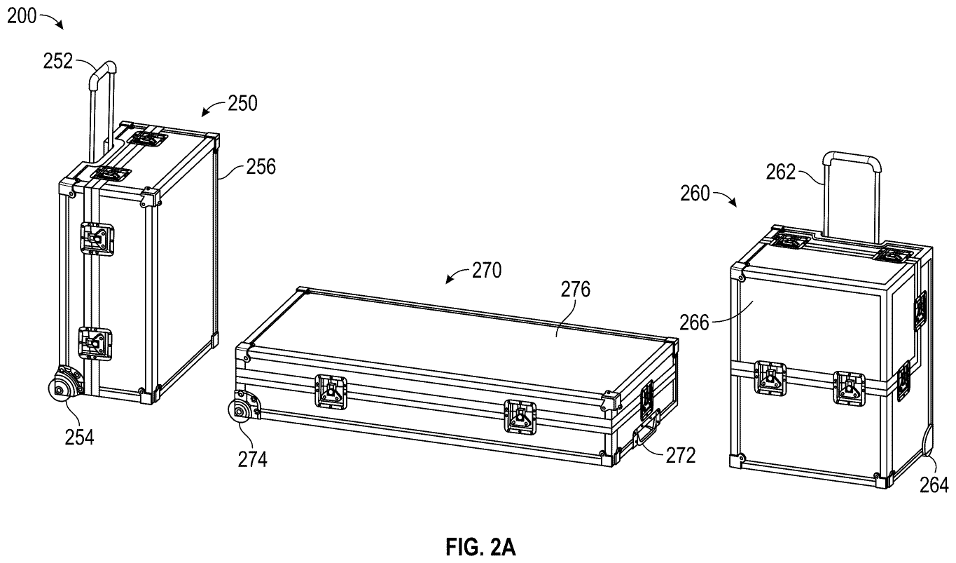

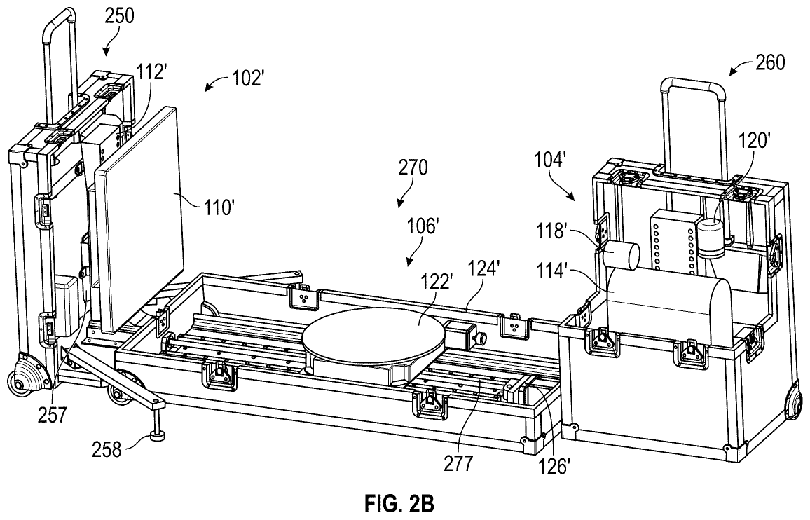

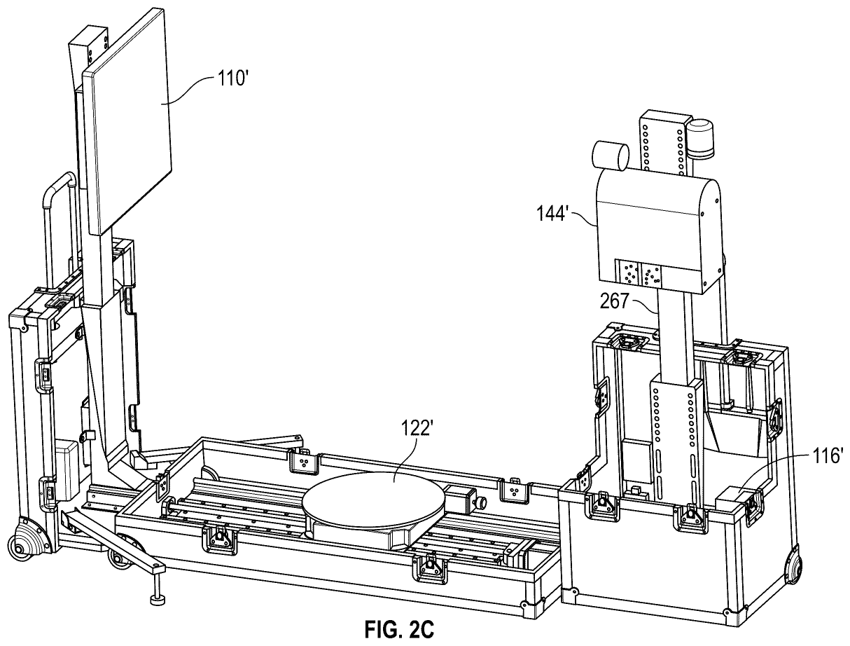

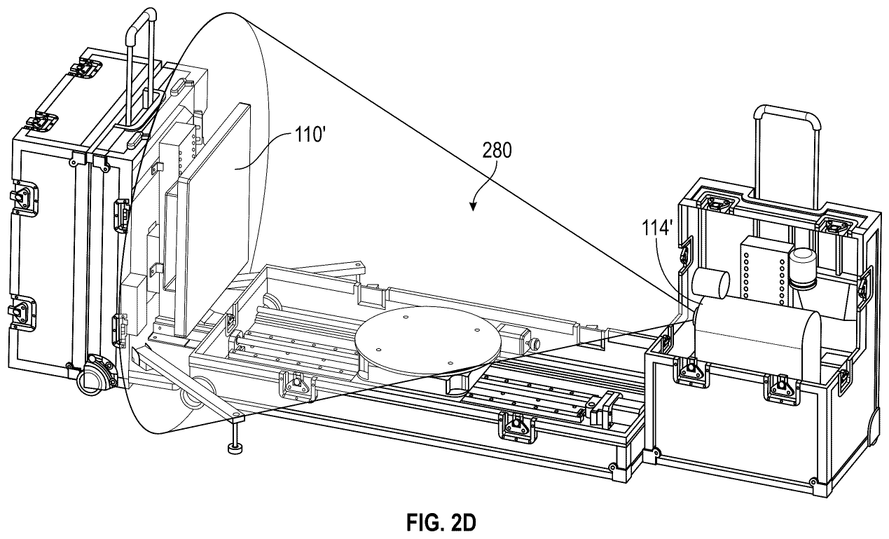

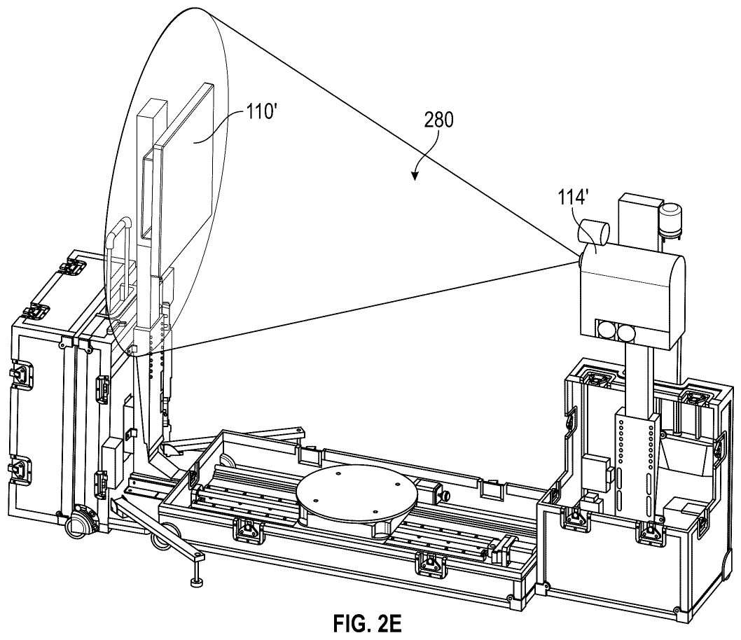

FIGS. 2A-2E illustrate a portable X-Ray and CT scan system 200 according to one embodiment of the present disclosure. FIG. 2A illustrates an example of mobile containers according to this embodiment. A first mobile container 250 is provided to house the detector package 102 described above. The first mobile container 250 includes a removable lid portion 256, a handle portion 252 and wheels 254 to provide a rollable and self-contained unit for the detector package 102. A second mobile container 260 is provided to house the source package 104 described above. The second mobile container 260 includes a removable lid portion 266, a handle portion 262 and wheels 264 to provide a rollable and self-contained unit for the source package 104. In this embodiment, the system 200 also includes a third mobile container 270 is provided to house the item platform package 106 described above. The third mobile container 270 includes a removable lid portion 276, a handle portion 272 and wheels 274 to provide a rollable and self-contained unit for the item platform package 106.

FIG. 2B illustrates the mobile containers 250, 260 and 270 in another example open and deployed position, i.e., with the respective removable lid portions 256, 266 and 276 removed to expose the detector package 102′, source package 104′ and the item platform package 106′, respectively. As illustrated, the detector package 102′ includes the X-Ray detector 110′ and controllable detector motor circuitry 112′, each described above. The X-Ray detector 110′ may be mounted on a linkage member 257 to enable movement (up and down movement) of the X-Ray detector 110′, via the controllable detector motor circuitry 112′. The linkage member 257 may include, for example, direct drive portions, pneumatic drive portions, a drive screw, one or more belts, rails, etc., and coupled to the controllable detector motor circuitry 112′ to provide controllable movement of the X-Ray detector 110′. The linkage member 257 may be configured for a desired granularity of movement of the X-Ray detector 110′, e.g., to with 0.1 mm. tolerance, etc. The mobile container 250 may also include one or more stabilizing arms 258 generally configured to extend away from the container 250 and provide a stable base for the detector package 102′ contained therein. The one or more stabilizing arms 258 may also include vibration dampening members, for example, rubber feet sections, rubber joint sections, etc.

As also illustrated in FIG. 2B, the source package 102′ includes the X-Ray source 114′ image sensor circuitry 118′ and alarm circuitry 120′, described above. The item platform package 106′ includes the controllable platform 122′, the rotational motor 124′ and the translational motor 126′. Also illustrated in linkage member 277 coupled to the platform 122′ and the translational motor 126′ to provide controllable translational motion of the platform 122′. In this embodiment, the linkage member 277 is a drive screw having a thread pitch/thread count for a targeted translational motion granularity, e.g., 0.1 mm tolerance.

FIG. 2C illustrates the mobile containers 250, 260 and 270 in an example open and deployed position. Compared to FIG. 2B, the detector 110′ and source 114′ are raised to accommodate, for example, a taller item placed on the platform 122. Also illustrated in FIG. 2C, the source 114′ is mounted on linkage member 267 to enable movement (up and down movement) of the X-Ray source 114′, via the controllable source motor circuitry 116′. The linkage member 267 may include, for example, direct drive portions, pneumatic drive portions, a drive screw, one or more belts, rails, etc., and coupled to the controllable source motor circuitry 116′ to provide controllable movement of the X-Ray source 114′.

FIG. 2D illustrates the X-Ray field 280 of the example open and deployed position of FIG. 2B, i.e., when the source 114′ and detector 110′ are turned ON to generate an X-Ray image (or series of X-Ray images). Similarly, FIG. 2E illustrates the X-Ray field 280 of the example open and deployed position of FIG. 2C, i.e., when the source 114′ and detector 110′ are raised and turned ON to generate an X-Ray image (or series of X-Ray images). Although FIGS. 2D and 2E illustrate the source 114′ and detector 110′ being generally horizontally aligned, in other embodiments the source 114′ and detector 110′ may be aligned to provide oblique X-Ray images (for example, the source 114′ being controlled to be higher than the detector 110′, or vise-versa).

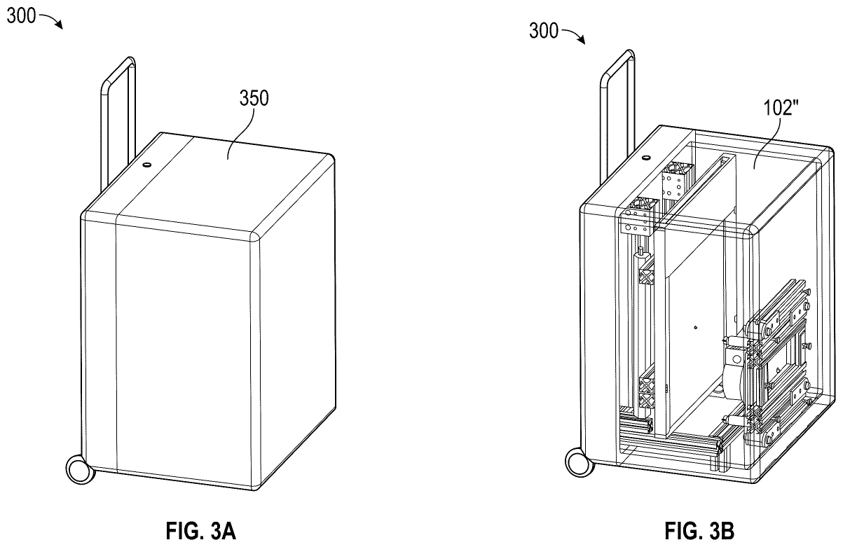

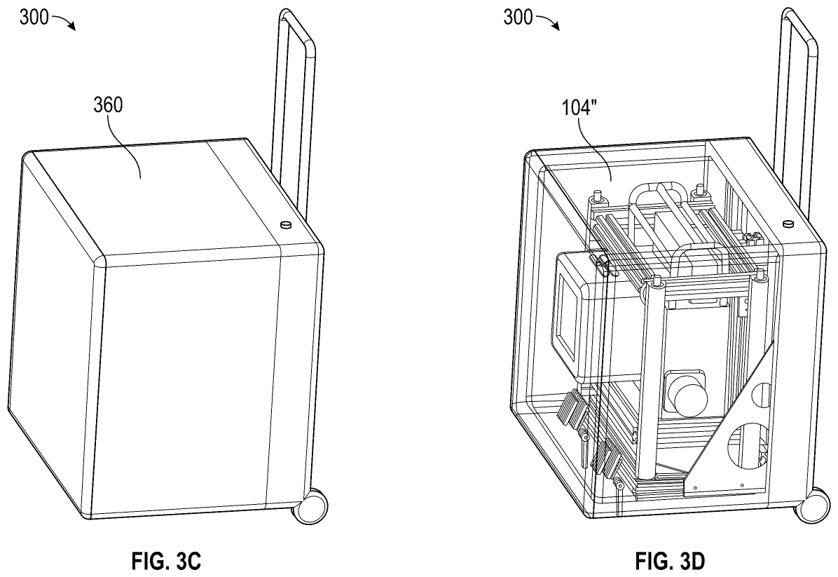

FIGS. 3A-3D illustrate a portable X-Ray and CT scan system 300 according to another embodiment of the present disclosure. FIG. 3A illustrates a mobile container 350 to house the detection package 102″, as shown in the partial cutaway view of FIG. 3B. Similarly, FIG. 3C illustrates a mobile container 360 to house the source package 104″, as shown in the partial cutaway view of FIG. 3D. The embodiment of FIGS. 3A-3D is similar to the embodiment of FIGS. 2A-2E, except container 270 may be omitted, and the item platform package 106 is located within the mobile container 350 and may be removed from the container 350 and placed on the floor, table, etc.

The internal structure of each of the mobile containers 250, 260, 270, 350 and 360 includes various slots, channels and/or chambers to affix and/or house the corresponding detector package 102, source package 104 and/or item platform package 106. Such slots, channels and/or chambers to affix and/or house components of the detector package 102, source package 104 and/or item platform package 106 within the respective mobile container 250, 260, 270, 350 and 360 may be modified, for example, depending on dimensions of selected components, desired tolerances within the body and between components, etc.

To provide portability of the mobile containers 250, 260, 270, 350 and/or 360, each of these mobile containers may have a size and weight that are generally movable by a single person. As such, the mobile container 250 may have a maximum size of 28″×23″×13″ with a maximum weight of 140 lbs. The mobile container 260 may have a maximum size of 27″×21″×16″ and a maximum weight of 140 lbs. The mobile container 270 may have a maximum size of 49″×23″×10″ and a maximum weight of 140 lbs. The mobile container 350 may have a maximum size of 28×23×19 with a maximum weight of 230 lbs. The mobile container 360 may have a maximum size of 25″×23″×23″ and a maximum weight 240 lbs. Of course, these are only example of the sizes and weights of the mobile containers. In other embodiments, the sizes and/or weights of the mobile containers may be based on, for example, requirements for certain field deployments, limitations of field personnel, shipping constraints, etc.

FIG. 4 illustrates an example GUI 400 according to one embodiment of the present disclosure. The GUI may be based on, or comply with, a Windows®-based application program interface (API), an iOS API, etc. and is generally configured to provide a user with control of the various components of the detector package 102, source package 104 and/or item platform package 106. The GUI may include various “windows” to display certain features of X-Ray and/or visual image capture. For example, window 402 illustrates an X-Ray image generated by the X-Ray source package 104 and X-Ray detector package 102 of an item placed therebetween. Window 404 illustrates a visual image of the item in window 402. Window 406 illustrates various controls for the X-Ray source package 104, X-Ray detector package 102, and item platform package 106. The GUI 400 provides the user with an Auto Calibration function allowing the system to perform the needed detector correction maps (i.e. dark field, bright field, dead pixel, etc.) with minimal knowledge required from the user. The GUI also permits the user to view a live stream of the X-Ray images (for example, up to 15 FPS) and manipulate the object in real time. The GUI 400 may also be enabled to generate a movie capture option to generate a movie clip (e.g., a 10 second movie clip, etc.) with the object rotating in a full 360 degrees. The GUI 400 may also enable playing the movie clip in the GUI, and exporting the movie clip (for example, to a mp4 file) for external viewing. The GUI 400 is also configured to capture full CT imaging datasets up to 0.036 degree accuracy, which may then be exported to a separate software for full 3D reconstruction and viewing. In example embodiments, The platform 120 is capable of 0.000625 degree accuracy, which would allow future versions of the GUI 400 to have increased CT resolution. In all of the above modes, once the capture is completed, The GUI 400 enable a user to view any/all previous images using the slider at the bottom of panels 402 and 404. During or after any of the capture functions, the GUI 400 also enables a user to manipulate the images to allow for better object detection by zooming in on the image, using for example, image filters (e.g., averaging, embossing, adaptive histogram, etc.), or by adjusting the histogram manually using the functions in the histogram window.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

Any of the operations described herein may be implemented in a system that includes one or more non-transitory storage devices having stored therein, individually or in combination, instructions that when executed by circuitry perform the operations. Such instructions may embodied as, for example, machine code, and/or “higher level” implementations such as software programing, application (app) programming, etc. “Circuitry”, as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry and/or future computing circuitry including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

The storage device includes any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device. Also, it is intended that operations described herein may be distributed across a plurality of physical devices, such as processing structures at more than one different physical location.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A portable X-Ray system, comprising:
a first portable container having a plurality of wheels, a handle, and a removable lid to expose an interior of the first portable container;
an X-Ray detector package housed within the first portable container; the X-Ray detector package comprising a controllable X-Ray detector panel configured to generate an X-Ray image and controllable detector motor circuitry configured to control a position of the X-Ray detector panel;
a second portable container having a plurality of wheels, a handle, and a removable lid to expose an interior of the second portable container; and
an X-Ray source package housed within the second portable container; the X-Ray source package comprising a controllable X-Ray source configured to generate X-Ray energy toward the controllable X-Ray detector panel and toward an item placed between the X-Ray source and the X-Ray detector panel, and controllable source motor circuitry configured to control a position of the X-Ray source.

2. The system of claim 1, wherein the X-Ray detector package further comprises linkage coupled to the controllable detector motor circuitry to raise and lower the controllable X-Ray detector panel.

3. The system of claim 1, wherein the X-Ray source package further comprises linkage coupled to the controllable detector motor circuitry to raise and lower the controllable X-Ray source relative to the X-Ray detector panel.

4. The system of claim 1, wherein the X-Ray source package further comprises image sensor circuitry to generate a visual image of the item.

5. The system of claim 1, wherein the X-Ray source package further comprises audible and/or visual alarm circuitry to generate an audible and/or visual alarm when the controllable X-Ray source is operating.

6. The system of claim 1, further comprising:
a third portable container having a plurality of wheels, a handle, and a removable lid to expose an interior of the third portable container; and
an item platform package housed within the third portable container; the item platform package comprising a controllable platform to support the item; controllable platform rotational motor circuitry configured to controllably rotate the platform to provide controllable X-Ray views of the item; and controllable platform translational motor circuitry configured to move the platform between the X-Ray source and the X-Ray detector panel to provide resolution and magnification control over the X-Ray image.

7. The system of claim 6, further comprising controller circuitry configured to provide circuitry user control over the controllable detector motor circuitry, the controllable source motor circuitry, the controllable platform rotational motor circuitry, and the controllable platform translational motor circuitry.

8. A portable X-Ray system, comprising:
a first portable container having a plurality of wheels, a handle, and a removable lid to expose an interior of the first portable container;
an X-Ray detector package housed within the first portable container; the X-Ray detector package comprising a controllable X-Ray detector panel configured to generate an X-Ray image and controllable detector motor circuitry configured to control a position of the X-Ray detector panel;
a second portable container having a plurality of wheels, a handle, and a removable lid to expose an interior of the second portable container;
an X-Ray source package housed within the second portable container; the X-Ray source package comprising a controllable X-Ray source configured to generate X-Ray energy toward the controllable X-Ray detector panel and toward an item placed between the X-Ray source and the X-Ray detector panel, and controllable source motor circuitry configured to control a position of the X-Ray source;
a third portable container having a plurality of wheels, a handle, and a removable lid to expose an interior of the third portable container; and
an item platform package housed within the third portable container; the item platform package comprising a controllable platform to support the item; controllable platform rotational motor circuitry configured to controllably rotate the platform to provide controllable X-Ray views of the item; and controllable platform translational motor circuitry configured to move the platform between the X-Ray source and the X-Ray detector panel to provide resolution and magnification control over the X-Ray image.

9. The system of claim 8, wherein the X-Ray detector package further comprises linkage coupled to the controllable detector motor circuitry to raise and lower the controllable X-Ray detector panel.

10. The system of claim 8, wherein the X-Ray source package further comprises linkage coupled to the controllable detector motor circuitry to raise and lower the controllable X-Ray source relative to the X-Ray detector panel.

11. The system of claim 8, wherein the X-Ray source package further comprises image sensor circuitry to generate a visual image of the item.

12. The system of claim 8, wherein the X-Ray source package further comprises audible and/or visual alarm circuitry to generate an audible and/or visual alarm when the controllable X-Ray source is operating.

13. The system of claim 8, further comprising controller circuitry configured to provide circuitry user control over the controllable detector motor circuitry, the controllable source motor circuitry, the controllable platform rotational motor circuitry, and the controllable platform translational motor circuitry.

14. A portable X-Ray system, comprising:
a first portable container having a plurality of wheels, a handle, and a removable lid to expose an interior of the first portable container;
an X-Ray detector package housed within the first portable container; the X-Ray detector package comprising a controllable X-Ray detector panel configured to generate an X-Ray image and controllable detector motor circuitry configured to control a position of the X-Ray detector panel;
a second portable container having a plurality of wheels, a handle, and a removable lid to expose an interior of the second portable container;
an X-Ray source package housed within the second portable container; the X-Ray source package comprising a controllable X-Ray source configured to generate X-Ray energy toward the controllable X-Ray detector panel and toward an item placed between the X-Ray source and the X-Ray detector panel, and controllable source motor circuitry configured to control a position of the X-Ray source;
a third portable container having a plurality of wheels, a handle, and a removable lid to expose an interior of the third portable container;
an item platform package housed within the third portable container; the item platform package comprising a controllable platform to support the item; controllable platform rotational motor circuitry configured to controllably rotate the platform to provide controllable X-Ray views of the item; and controllable platform translational motor circuitry configured to move the platform between the X-Ray source and the X-Ray detector panel to provide resolution and magnification control over the X-Ray image; and
controller circuitry configured to provide circuitry user control over the controllable detector motor circuitry, the controllable source motor circuitry, the controllable platform rotational motor circuitry, and the controllable platform translational motor circuitry.

15. The system of claim 14, wherein the X-Ray detector package further comprises linkage coupled to the controllable detector motor circuitry to raise and lower the controllable X-Ray detector panel.

16. The system of claim 14, wherein the X-Ray source package further comprises linkage coupled to the controllable detector motor circuitry to raise and lower the controllable X-Ray source relative to the X-Ray detector panel.

17. The system of claim 14, wherein the X-Ray source package further comprises image sensor circuitry to generate a visual image of the item.

18. The system of claim 14, wherein the X-Ray source package further comprises audible and/or visual alarm circuitry to generate an audible and/or visual alarm when the controllable X-Ray source is operating.
